(19) United States
(12) Patent Application Publication
(10) Pub. No.: US 2008/0101708 A1
(43) Pub. Date: May 1, 2008

(54) Method, Device And Software For Improving The Quility Of A Video Recording

(76) Inventor: Janne Lahteenmaki, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/662,913

(22) PCT Filed: Sep. 14, 2005
(86) PCT No.: PCT/FI05/50315

§ 371 Date: Mar. 14, 2007

(30) Foreign Application Priority Data
Sep. 14, 2004 (FI) 20045340

(51) Int. Cl. G06K 9/36

(52) U.S. Cl. 382/236

(57) ABSTRACT

The invention relates to improving the image quality of a video recording made in particular at a low bitrate. In a method according to the invention, motion of a video camera is observed during a recording process, and any such detected video camera motion that weakens the image quality of the video recording in question is indicated to the user.

The invention relates particularly to improving the image quality of a video recording recorded at a low bitrate.

When a video camera is moved too rapidly during the recording process, the result is blur in the video image. When looking at a video image, too rapid motion during the recording is shown as disturbing. Typically the image is blurred and details cannot be distinguished, because the image is not sharp. Usually this kind of video recording is useless. Therefore already the instructions advise the user how to move the camera during the recording process, and point out that too rapid motion is recorded as blurred.

Typically a blurred video recording is rejected as useless, and it is replaced by a new recording. Thus the cameraman has a chance, through trial and error, next time pay more attention to the moving of the camera and to the speed of the motion, and further to try and reduce such moving of the camera that is excessive or too rapid from the point of view of the final video recording.

Generally the user realizes that too rapid motion has a negative effect on the final image when he reads the warnings in the instructions, or when he moves his video camera too rapidly when shooting and sees that the quality of the recorded image is poor. Although the camera motion during the shooting process affects image quality, the user detects the effects of the motion only when looking at the final picture.

The object of the present invention is to help the user shoot and record higher-quality video image.

This object is achieved so that the user is given an indication of such camera motion during the recording process that is too rapid and weakens the image quality.

The invention is characterized by what is set forth in the characterizing parts of the independent claims. Other embodiments of the invention are described in the dependent claims.

In a method according to the embodiments of the invention, in order to facilitate the controlling of the image quality in a video recording carried out by a video camera, the motion of the video camera is observed during the recording process, and any such detected motion of the video camera that weakens the image quality of the video recording is indicated to the user. The motion of the video camera is observed in an image processing step. According to an embodiment, when controlling the motion of a video camera according to the embodiments, motion vectors already produced in the image processing are made use of. According to an embodiment of the invention, the magnitude and direction of the motion vectors are compared, and in case a difference is detected to be larger than a given predetermined threshold value, i.e. there is detected too rapid motion that weakens the image quality of the video recording in question, there is generated an indication to the user of the detected video camera motion that weakens the image quality.

A device according to an embodiment of the invention, provided with a video camera for shooting the video recording, includes means for observing the motion of the video camera during the recording process, and means for indicating to the user such motion that weakens the image quality of the video recording in process. A device according to an embodiment of the invention is a video camera provided with means for performing the methods according to the embodiments of the invention. A device according to an embodiment is provided with means for comparing the magnitude and/or direction of the motion vectors. In addition, the device according to the embodiment comprises a source encoder for generating motion vectors and a memory unit for recording the data. In the memory unit, there is typically saved data generated in the image processing, such as the data of the motion vectors. In addition, the memory unit may contain a code for running the methods according to the embodiments of the invention. According to another embodiment, the device includes software for running the methods according to the embodiments of the invention. The software comprises program means for observing the motion of a video camera during the recording process, and means for indicating to the user such motion of the video camera that weakens the image quality of the video recording in question.

According to the embodiments of the invention, too rapid motion of the camera that weakens the image quality is indicated to the user immediately during the shooting process. The lower the bitrate by which the camera records successive images, the more the motion is in the final image seen as disturbing blurriness. Hence the embodiments of the invention are particularly useful when shooting video recordings at low bitrates. The observation of the video camera motion takes place already in the image processing step, which means that the user obtains indication of too rapid motion already during the shooting, and can thus influence the final video recording already in the shooting step, and not only after seeing the final poor-quality picture. This is particularly useful when shooting unique targets or situations that cannot be repeated and rerecorded. The arrangement according to a preferred embodiment of the invention can be realized easily, because new devices are not needed. The method according to the embodiments of the invention can be realized by means of a software component or by a program code saved in the memory. According to an embodiment, video camera motion is observed by means of motion vectors. Motion vectors are generally used in image processing, which means that they are calculated for the images in any case. Thus the use of motion vectors in the various embodiments does not typically increase the power or capacity requirements of the device, because the motion vectors are already generated as part of the image processing.

Let us now observe embodiments of the invention with reference to the appended drawings, where

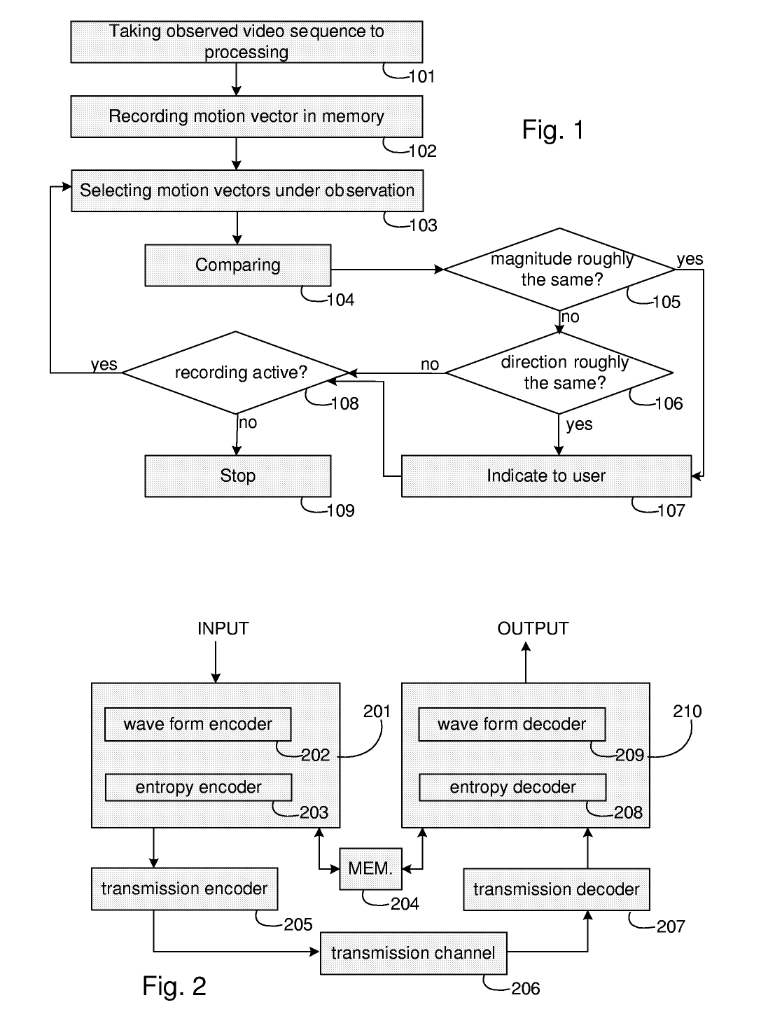

FIG. 1 illustrates a method according to an embodiment of the invention,

FIG. 2 illustrates an arrangement according to an embodiment of the invention,

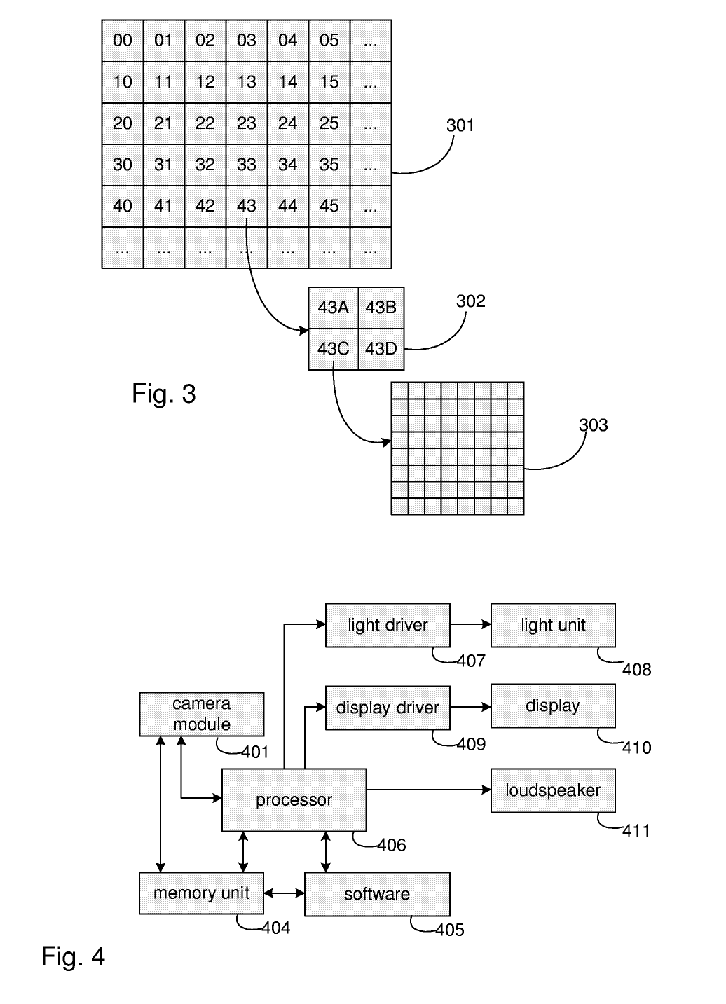

FIG. 3 is a graphical illustration of video data frames according to an embodiment of the invention, and

FIG. 4 illustrates an arrangement according to an embodiment of the invention.

Said drawings are referred to in the following description of the embodiments of the invention, and in the further specification, the drawings constitute part of the description. The drawings illustrates examples of embodiments where the invention can be applied. Naturally also other embodiments can be utilized, and structural and functional modifications can be made in the embodiments without departing from the scope of the invention.

FIG. 1 illustrates a method according to an embodiment of the invention for facilitating the observation of the image quality of a video recording made by a video camera. In the embodiment of FIG. 1, the motion of the video camera is observed during the shooting process, and as a response to an observation of a too rapid video camera motion that weakens the image quality of the video recording in question, the user obtains an indication of the too rapid motion of the video camera. In step 101, the user shoots with his video camera, and the camera device receives the video sequence to be processed. The recorded video sequence to be processed is encoded by an image processing mechanism known as such. In this embodiment, motion vectors describing the differences between successive images are calculated in the image processing step. The generated motion vectors are saved in the memory in step 102. Motion vectors to be observed according to the embodiment of the invention are selected in step 103. According to an embodiment, all generated motion vectors are observed. According to another embodiment, there is selected, by applying certain criteria, a comprehensive set that is then observed. Motion vectors can be observed for instance at certain intervals. According to an embodiment, motion vectors of a certain block or blocks are chosen to be observed. Motion can be detected in a given part of the camera image, for example in the center, which means that there is no need to compare all of the block specific motion vectors of the whole image. In addition, it is possible to observe for instance the motion vectors of a given, selected target. There are typically chosen some points or blocks of observation, and the possible motion of the camera is detected by observing these. Generally there are at least two points or blocks under observation on different sides of the image, in which case it is more probable that the detected motion really is the motion of the camera, and not for example blockwise motion of for instance a target shown in the picture.

When the motion vectors under observation are selected in step 103, the motion vectors are mutually compared in step 104. There is typically defined a threshold value for the direction and magnitude of the motion vectors, as well as for the differences between their points of observation, and the motion vectors are compared with said threshold values. When observing video image, the motion between successive images is fairly small, because the image density per unit of time is fairly high. On the basis of this, there is defined a threshold value, and when said threshold value is surpassed, the motion in question is more probably the motion of the camera than the motion of a target shown in the image. In this embodiment, in step 105 it is for example observed whether the motion vector magnitude surpasses a given predetermined threshold value. In case the magnitude is higher than the defined threshold value, we proceed to step 107, where an indication of too rapid camera motion is given to the user. In step 105 the camera motion can also be detected on the basis that the magnitude of the motion vectors on different sides of the image is equal. In that case the motion in question is more probably the motion of the camera than that of a recorded target. In case the value detected in step 105 does not surpass the threshold value, and disturbing camera motion is not detected, we proceed to step 106, where the directions of the motion vectors, as well as differences in the directions, are observed. In case the directions of the motion vectors observed at different points of the image differ more than for a given predetermined threshold value, the phenomenon in question is probably the motion of a given target shown in the image. On the other hand, camera motion is focused with the same magnitude and in the same direction on the whole image area, i.e. the directions of the motion vectors do not remarkably differ. In case the directions of the motion vectors under observation, located in different parts of the image, are the same at a given accuracy, the phenomenon in question is probably camera motion. If said motion is detected to be so fast that it disturbs the produced image, this is indicated to the user according to step 107. When the user has been given an indication by generating by the device an effect detectable for the user that indicates too rapid camera motion, the system proceeds to step 108. In case disturbing motion was not detected in steps 105 or 106, the execution proceeds to step 108. In step 108 it is observed whether the user is still recording with his video camera. If the user has finished shooting, the process according to the embodiments of the invention is terminated in step 109. In case the camera is active and shooting is going on, the execution proceeds to step 103 and select the next motion vectors under observation.

FIG. 2 illustrates an arrangement according to an embodiment for processing video data. The arrangement includes a source encoding block 201 and a corresponding decoding block 210 that decodes the encoding carried out by the source encoding block 201. In the source encoding block 201 the supplied video signal is compressed to a desired bitrate and there is produced an encoded, compressed video signal. In the decoding block 210 that decodes the source encoding, the encoding and compression are decoded, and the original video signal is reconstructed.

The recorded video data, i.e. signal, is fed in through the input side. First the signal is source encoded by a wave form encoder 202, where a lossy video signal compression is carried out. An entropy encoder 203 converts the output from the wave form encoder 202 into a binary sequence. The entropy encoder 203 also produces motion vectors. Thus, the comparison of the motion vectors according to the embodiment of the invention is carried out after this image processing step, when the motion vector is produced. Already produced motion vectors can be utilized when observing excessive motion of the video camera according to the embodiments of the invention.

The source encoded binary sequence can be for example saved in the memory unit 204 of the device. Typically also the produced motion vectors are saved in the memory unit 204. The memory unit 204 can be the memory unit of the device, and a certain part of it can be allocated for the use of the source encoding block 201. The source encoding block 201 can also include its own separate memory unit. Motion vectors can be saved for instance so that the data is stored for a certain time. Typically a certain amount of memory is reserved for the motion vectors, and when said memory section is full, the next new motion vector is saved so that it replaces the oldest previous vector. According to an embodiment of the invention, the memory unit 204 also includes a set of instructions, for example a command set to be run, a software or a program code for performing the methods according to the embodiments of the invention.

Some devices also include a feature for transmitting video data to another device. In that case the binary sequence is transmitted to a transmission encoder 205 that encapsulates the compressed video data according to the applied transmission protocol, and the encapsulated video data is transmitted along the transmission channel 206 to the receiver. In the arrangement of FIG. 2, there also are represented the corresponding source decoder 210 and transmission decoder 207 for decoding the codes. The video data received through the transmission channel 206 is first processed in the transmission decoder 207 where the encoding made by the transmission encoder is decoded. Apart from encapsulation, the transmission encoder 205 may have for example modulated or multiplexed the video data. The transmission decoder 207 transmits video data to the source decoder 210. The source decoder 210 can also receive data for example from the memory unit 204. The entropy decoder 208 and wave form decoder 209 of the source decoder 210 perform the decoding so that there is created a reconstructed video signal to be transmitted to the display on the output side.

The signal coming from the video camera to the source encoder is also called a video sequence. A video sequence is composed of a series of still images. According to an embodiment of the invention, the still images in a video recording composed of still images are compared in order to detect motion of the video camera. In case in the still images to be compared, either successive still images or still images taken at certain intervals, there is detected a difference that can be seen in the final video image, this is indicated to the user already during the recording process. Still images can be observed in the video sequence processing step, as part of image processing. In the image processing step, the video sequence is typically compressed by reducing redundant elements that do not affect the final image quality. The redundancy in a video sequence can be classified as a spatial, timewise or spectral redundancy. Spatial redundancy refers to corrections between adjacent pixels in the same image. Timewise redundancy is based on the fact that the targets shown in the previous image are probably shown also in the current image. Spectral redundancy refers to corrections between the various color components of the image.

Timewise redundancy can be reduced by producing motion compensated data. This kind of data describes the relative motion between the previous image and the current image. The current image is typically created so that it is forecast on the basis of the previous image. The technique used in the method is generally called motion compensated forecast or motion compensation. This method can also be utilized so that only certain parts or areas in the image are forecast on the basis of the previous image.

According to an embodiment, camera motion can be detected by means of external sensors, for example acceleration sensors. Signals from external sensors are observed for detecting camera motion. Typically for example acceleration has a threshold value, and when said threshold value is surpassed, the image quality is weakened remarkably and visibly. Detected too rapid motion is indicated to the user according to the embodiments.

Protocols related to digital video data define the form of the video data and include video data compression algorithms. Generally known protocols are for example MPEG (Motion Picture Experts Group) protocols and H.261, H.263 and H.264 based on discreet cosine transform. When compressing video data, i.e. during the encoding process, the protocols define how the redundant image areas of the previous frames are made use of. In a much used compression technique, for the encoded frame part, there is produced a motion vector that indicates the point where the corresponding image element was located in the previous image. An advantage in the use of motion vectors is that the quantity of the transmitted or saved data is remarkably reduced, because only the difference between two images must be saved. Consequently, motion vectors are generally used in image processing.

For processing video data, a signal is typically divided into frames with a certain size. FIG. 3 shows a frame structure 301. A frame 301 is composed of pixel series that are typically numbered from 00 to 99. According to the MPEG protocol, the pixel series 00-99 are called macro blocks. Each macro block is composed of four data blocks. Here a data block 302 is illustrated as an example for the macro block number 43. The data block 302 is composed of an 8×8 pixel group 303. When encoding video data, and consequently when producing motion vectors, this can be carried out separately for each macro block. When encoding, it also is possible to use other pixel series than macro block specific pixel series. The encoding process can be carried out block by block, or for pixel series of some other size. A macro block in the frame structure can be compressed by transforming its pixels on the basis of the pixels in the previous corresponding frame. Thus the previous frame serves as a framework for the next frame that is currently being processed. Typically the previous frame is encoded before the still image sequence frame that is next in order. Thus the macro blocks of the previous encoded frame include compressed data that contains information of the motion vector of the frame in question.

A motion vector can be forecast for the macro block to be encoded. The motion vector of the macro block can be forecast on the basis of the motion vectors of the macro blocks located adjacent thereto, either immediately, orthogonally and/or diagonally. In addition to the motion vectors of the already verified adjacent frames, or instead of them, the forecast can take into account the motion vectors of those macro blocks that in the previous framework are placed adjacent to the macro block located in the respective place. According to an embodiment, a macro block motion vector is forecast on the basis of selected reference motion vectors. According to another embodiment, an average is calculated from the reference motion vectors. According to a third embodiment, a median is calculated from the reference motion vectors. The reference motion vectors can also be weighted when evaluating the next motion vector. When a motion vector is forecast for the macro block to be encoded, the forecast can be used as a motion vector for the macro block to be encoded, or it can be used as a starting point for the encoding process, where the final motion vector for the macro block is defined. Every macro block does not necessarily have a motion vector. In that case, there is typically used a predetermined standard value, or the value of the motion vector of the macro block that in the previous frame was located on the corresponding spot.

According to an embodiment of the invention, the motion vectors of still images, generated by the source encoder, are compared so that all motion vectors of an image are mutually compared. In case the direction and length of the observed motion vectors is roughly the same, the phenomenon in question is camera motion. According to another embodiment of the invention, the motion vectors of still images, generated by the source encoder, are compared so that the motion vectors of still images taken at certain intervals are observed. According to an embodiment of the invention, the motion vectors of still images are compared block by block, so that the motion vectors of a certain block in the still image are mutually compared. According to an embodiment, the motion vectors of the still images are compared so that the motion vectors of a certain target shown in the still images are mutually compared. By observing the motion vectors according to the embodiments, it is detected already in the recording step whether the image includes so much motion that the video recording cannot be shown as a sharp image. According to the embodiments, an indication is given to the user to the effect that the resulting video recording is not sharp, but the image quality is poor and blurry. According to the embodiments, the user receives this indication, when excessive, disturbing motion is detected. Said motion can be due to the motion of the camera or the motion of the recorded target.

FIG. 4 illustrates an arrangement according to an embodiment of the invention for indicating to the user excessive motion that weakens image quality during the recording process. In the embodiment of FIG. 4, only those parts of the arrangement that are most essential for the invention are shown. In addition, the arrangement can include other elements and functional blocks. The camera module 401 contains a camera sensor and a signal processing block. The recorded, processed video data is directed from the camera module 401 to the processor 406. The signal processing block typically includes a source encoder provided with a wave form encoder that compresses video signal, and an entropy encoder that converts the output from the wave form encoder into a binary sequence. Also the motion vector is modeled in the entropy encoder. According to this embodiment, the motion vectors are saved in a memory unit 404. In addition to the memory unit of the device, there can also be used an internal or external memory unit pertaining to the signal process block of the camera module 401. According to an embodiment, in the memory unit 404 there are saved all motion vectors that are modeled in the entropy encoder. According to another embodiment, certain motion vectors, for example the motion vectors of certain pixel series or macro blocks, are taken into account when processing the motion vectors according to the embodiments of the invention. As an alternative, there can be chosen a target in the video image, and the motion vectors related to said target are observed according to the embodiments of the invention. According to an embodiment of the invention, the device includes means for observing the motion vectors of a still image in a video recording composed of still images. A device according to this embodiment includes means for mutually comparing the motion vectors of the still image. Typically said device is provided with means for comparing the magnitude and/or direction of the motion vectors. According to the embodiments, it also is possible to observe and compare the motion vectors of successive images of a given target, or the motion vectors of given macro blocks. It is not always necessary to observe every one of the successive still images, but even several unprocessed still images can be left between the images.

According to an embodiment, motion vectors saved in the signal processing block or in the memory unit 404 of the device are observed by comparing their magnitude and/or direction. According to an embodiment, the memory unit 404 includes, in addition to the motion vector data, a program code, according to which the motion vectors under observation are selected, and on the basis of which the motion vectors are compared. According to an embodiment, in case the direction and/or magnitude of all of the motion vectors under observation is the same at a given accuracy, the program code includes a command to indicate this to the user in a defined way. According to an embodiment, in case the magnitude and/or direction of the motion vectors under observation turns out to be higher than a predetermined threshold value, the program code includes a command to indicate this to the user in a defined way. The motion vectors are processed according to the commands and instructions of the program code by the processor 406. When an indication should be given to the user of too rapid motion, i.e. too big a difference between two motion vectors under observation, the processor 406 transmits a command for indicating excessive motion to the user. Generally the detected too rapid motion is indicated to the user so that there is produced a sound effect by sound reproduction means, a light effect by a light unit, a vibration effect by a vibration unit and/or a graphic effect on the display. The processor 406 can transmit a command for example to the light driver 407 for switching on the light unit 408 of the device or a signal light, to the display driver 409 for indicating the motion on the display unit 410 or to the loudspeaker 411 for producing a sound signal. Corresponding blocks by which an indication of detected too rapid motion can be given to the user during the video recording process are for example a vibration unit that is controlled through a vibration driver, or the sound reproduction means of the device, such as MIDI (Musical Instrument Digital Interface) or MP (MediaPlayer).

According to another embodiment, the arrangement includes software 405 by which the procedures according to the various embodiments of the invention are carried out by the processor 406. The software 405 for facilitating the observation of image quality includes program means for observing the motion of a video camera during the recording process, and program means for giving to the user, already during the recording process, an indication of too rapid video camera motion that weakens the image quality of the video recording in question. The software 405 includes program means for comparing the motion vectors and program means for giving an indication to the user, in case the magnitude and/or direction of the compared motion vectors selected from a still image is the same at a given accuracy and/or in case it is higher than a given predetermined threshold value. Generally the processing is carried out by a processor 406. An arrangement according to the embodiments of the invention can be realized by means of already produced motion vectors and a program code stored in the memory unit, or alternatively by means of a separate software component. Any additional devices are not needed. The arrangement according to the invention for indicating excessive camera motion during a video recording can be applied particularly in devices provided with a small camera typically having a low bitrate. Small cameras and low bitrates generally occur in portable devices, such as mobile phones, pen micros (PDA, Personal Digital Assistant), communicators and corresponding mobile devices.

1. A method for facilitating the observation of the image quality of a video recording made by a video camera (401), characterized in that motion of the video camera (401) is observed during a recording process (104), and that such detected motion of the video camera that weakens the image quality of the video recording in question is indicated (107) to the user.

2. A method according to claim 1, characterized in that a still image of the video recording is observed for detecting video camera motion.

3. A method according to claims 1-2, characterized in that the motion vectors (103) of the still image of the video recording are observed in order to detect video camera motion.

4. A method according to claim 3, characterized in that the video camera motion is detected to weaken image quality, when the magnitude (105) and/or direction (106) of the observed motion vectors of a given still image are the same at a given accuracy.

5. A method according to claims 3-4, characterized in that the video camera motion is detected as weakening the image quality, when the magnitude (105) and/or direction (106) of the observed motion vectors of a given still image surpasses a given predetermined threshold value.

6. A method according to any of the preceding claims, characterized in that among the motion vectors of a given still image, generated by a source encoder (201), all of said motion vectors are selected to be observed.

7. A method according to any of the preceding claims, characterized in that among the motion vectors of a given still image, generated by a source encoder (201), certain motion vectors are selected to be observed on the basis of certain criteria.

8. A method according to claim 7, characterized in that the motion vectors of a still image are selected block by block (301, 302), so that the motion vectors of certain blocks in the still image are mutually compared (104).

9. A method according to any of the preceding claims, characterized in that the detected motion weakening the image quality is indicated to the user, so that there is generated a sound effect by sound reproducers (411), a light effect by a light unit (408), a vibration effect by a vibration unit and/or a graphic effect on the display (410).

10. A video camera for making a video recording, characterized in that it comprises means for realizing the methods according to claims 1-9.

11. A device provided with a video camera (401) for making a video recording, characterized in that it comprises means for observing motion of the video camera (401) during a recording process, and means for indicating to a user (408, 410, 411) such motion that weakens the image quality of the video recording in question.

12. A device according to claim 11, characterized in that it comprises means for observing (401, 406) a still image in a video recording including still images.

13. A device according to claims 11-12, characterized in that it comprises means for observing (401, 406) the motion vectors of a still image in a video recording including still images.

14. A device according to claim 13, characterized in that it comprises means for observing and comparing (401, 406) the magnitude and/or direction of the motion vectors.

15. A device according to claims 11-14, characterized in that it comprises a source encoder (201) for generating motion vectors, a memory unit (204, 404) for reducing data and means for comparing (401, 406) the motion vectors of a still image.

16. A device according to claims 11-15, characterized in that it comprises a source encoder (201) for generating motion vectors, a memory unit (204, 404) for recording data and means for observing and comparing (401, 406) the direction and magnitude of a still image.

17. A device according to claim 15 or 16, characterized in that it comprises means for comparing (401, 406) the motion vectors of certain blocks (301, 302) in the still image under observation.

18. A device according to claims 11-17, characterized in that it comprises a light unit (408), a display unit (410), a loudspeaker (411), a vibration unit and/or sound reproducers for indicating to the user such detected video camera motion that weakens the image quality.

19. A device according to claims 11-18, characterized in that it is provided with a memory unit (404) including a program code for performing the methods according to claims 1-9 by a processor (406).

20. A device according to claims 11-18, characterized in that it includes a software (405) for performing the methods according to claims 1-9 by a processor (406).

21. Software for facilitating the observation of the image quality of a video recording made by a video camera (401), characterized in that it includes program means (405) for observing motion of the video camera during the recording process, and program means (405) for indicating to a user such video camera motion that weakens the image quality of the video recording in question.

22. Software according to claim 21, characterized in that it includes program means (405) for comparing a magnitude and a direction of motion vectors under observation, generated by a source encoder (201).
